(19) United States
(12) Patent Application Publication
(10) Pub. No.: US 2006/0254408 A1
(43) Pub. Date: Nov. 16, 2006

(54) Recording control method

(75) Inventors: Hirofumi Yamaguchi, Ibaraki-shi (JP); Hitoshi Fujita, Ibaraki-shi (JP); Naoto Sawada, Neyagawa-shi (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/431,582

(22) Filed: May 11, 2006

(30) Foreign Application Priority Data
May 16, 2005 (JP) 2005-142439

(51) Int. Cl. G10H 1/00

(52) U.S. Cl. 84/601

(57) ABSTRACT

The present invention comprises the steps of: when there is a change of music-piece, writing the last data of previous piece of music stored in a storage device to a recording medium; writing the front data of the next piece stored in the storage device; and executing file operation to change the music-piece after writing the front data of the next piece. By executing a part of the file operation to change the music-piece at other time than the change of music-piece, buffer referring time during the piece-change processing can be shortened.

### BACKGROUND OF THE INVENTION

1. Field of the Invention

The present invention relates to a recording control method for recording music data which is inputted successively from a music playback equipment and the like, is recorded by each piece of music with a file form onto a recording medium which is formatted by a file system, and a recording apparatus with which the control method is carried out.

2. Description of the Related Art

Digital video players such as hard disc players and CD-R (Compact Disc-Recordable) players have become popular as recording apparatuses to record music data with a file form which is inputted successively from a music playback equipment and the like onto a recording medium that is formatted by a file system.

The above-described recording apparatus comprises a control device for encoding and encrypting music data, and a system controller (recorder) for performing control of writing of the music data into a recording medium upon receiving a writing request from the control device. Data exchange between the control device and the system controller is carried out through a storage device.

FIG. 1 is a block diagram to show the structure of a typical recording apparatus. In FIG. 1, reference numeral 1 is a music data output device for outputting music signals or music data. 2 is a control device which compresses or encrypts the inputted music data and writes it to a storage device 3. 3 is the storage device for storing data files. 4 is a system controller (recorder) which reads out the music data stored in the storage device 3 by controlling a recording medium interface 5, and writes it to a recording medium 6. 5 is a recording medium interface to access to a recording medium 6. 6 is the recording medium formatted in a file system.

After the control device 2 encodes or encrypts the music data inputted successively from the music data output device 1 at carrying out recording action, the music data, which is signal-processed in this way, is stored to the storage device 3 by every certain size. The storage device 3 is divided into a plurality of buffers #1, #2, #3, and the order to write in is changed by the control device 2. When there is no more remainder available in the storage device 3, the system controller 4 reads out the music data in the storage device 3 and writes the music data to the recording medium 6 through the recording medium interface 5. In this way, recording can be achieved according to successive input.

In the followings, there will be described processing procedures of recording action of the related art by referring to FIG. 10 and FIG. 11. FIG. 10 is a flowchart to show the processing at the time of recording action performed by the system controller 4. FIG. 11 is a flowchart to show a file operation step when there is change of music-piece occurred in the system controller 4.

In step S71, the system controller 4 enters into a recording loop. In step S72, it is judged whether or not there is change of music-piece. When there is no change of music-piece (No in step S72), it proceeds to step S73 to write all music data in the buffers of the storage device 3 to the recording medium 6. On the other hand, when it is judged that there is change of music-piece (Yes in step S72), it proceeds to step S74 to write the last data of the music data of the previous piece in the storage device 3 to the recording medium 6. In the cases where there is music-piece change information within the music data or there is a request by a user for changing the music-piece, the music data of two pieces of music, i.e. the last data of the previous piece and the front data of the next piece, are stored in the storage device 3. Then, file operation to change music-piece is carried out in step S75.

This file operation to change music-piece is carried out as illustrated in FIG. 11. That is, in step S81, an ending process is executed to finish the writing processing of the music data of the previous piece to the recording medium (closing processing of the music data of the previous piece). Then, in step S82, the processing is performed to write key information for decrypting the encryption of the music data of the previous piece to the recording medium. Subsequently, the processing is carried out in step S83 to write the music information of the previous piece to the recording medium. The music information herein is additional information of the music including a content table (index and the like) of each of music piece. Then, in step S84, opening process to file of the next music-piece is performed to generate the music data of the next piece. Subsequently, it proceeds to step S76 in FIG. 10 to write the front data of the music data of the next piece to the recording medium 6. By repeating the recording action described above, it is possible to achieve a function of recording successively inputted music data by each piece as a file.

When input data amount increases for a specific time due to higher double-speed and high-quality on recording, the time when the system controller 4 refers to the music data within the storage device 3 increases relatively. Thereby, it happens that the control device 2 overwrites the music data in the storage device 3 to which the system controller 4 is referring. As a result, the music data that is not intended is written to the recording medium, thereby increasing the probability of failing the recording.

Therefore, for example, as disclosed in Japanese Patent published Literature (Japanese Patent Unexamined Publication 2000-123477), a method has been proposed to avoid recording failure by decreasing the input data amount or temporarily stopping input before lack of data happens due to processing omission.

In the related art, when input data amount increases for a specific time due to higher double-speed and high-quality on recording, the time when the system controller 4 refers to the music data in the storage device 3 increases relatively during the file operation to change the music-piece (step S75). The file operation to change the music-piece is carried out between the writing process the last data of the music data of the previous piece to the recording medium 6 (step S74) and the writing process the front data of the music data of the next piece to the recording medium 6 (step S76) As a result that it becomes longer for the system controller to refer to the storage-device, the processing of the system controller 4 cannot catch up with the writing requests, thereby increasing the probability of recording failure. It is possible to overcome such inconvenience by increasing the processing speed of the system controller 4 or the access speed to the recording medium 6, however, an increase in the cost due to speed-up becomes inevitable.

### SUMMARY OF THE INVENTION

In order to overcome the aforementioned problems, the recording control method of the present invention is a recording control method for recording music data, which is inputted successively, by each piece with a file form to a recording medium formatted by a file system, wherein: last data of previous piece stored in the storage device is written to the recording medium when there is a change of music-piece, then, front data of next piece stored in the storage device is written to the recording medium; and further file operation to change the music-piece is executed thereafter.

According to this, reference time of the storage device in execution of the file operation to change the music-piece can be shortened by executing the writing processing of the front data of the next piece under occurrence of music-piece change immediately after the writing processing of the last data of the previous piece. Therefore, it is possible to execute the recording action without increasing the processing speed of the system controller and the access speed to the recording medium even if there is an increase in the input data amount for a specific time due to higher double-speed and high-quality, for example.

In the above-described method, the file operation to change the music-piece includes a closing processing on the previous-piece file to end formation of a data file recorded in the recording medium, previous-piece key information writing processing to write key information of the previous piece in an authentication area of the recording medium, and a writing processing on previous music-piece information to write music information of the previous piece to a file, wherein it is preferable to execute the next-piece file opening processing between writing of the last data of the previous piece to the recording medium and writing of the front data of the next piece to the recording medium.

In the case that the writing processing of the front data on the next piece is performed immediately after the writing processing on the last data of the previous piece, it is necessary to perform at least the next-piece file opening processing to form the next-piece file in the recording medium when the writing processing of the front data of the next piece is started.

Further, in the above-described method, the file operation to change the music-piece includes a closing processing on the previous-piece file to end formation of a data file recorded in the recording medium, a previous-piece key information writing processing to write key information of the previous piece in an authentication area of the recording medium, and a writing processing on previous music-piece information to write music information of the previous piece to a file, wherein it is preferable to execute the next-piece file opening processing in a free time before occurrence of the change of music-piece.

Further, in the above-described method, the previous-piece key information writing processing may be executed in a free time before occurrence of the change of music-piece.

Furthermore, in the above-described method, the file operation to change the music-piece includes a previous-piece key information writing processing to write key information of the previous piece in an authentication area of the recording medium, a writing processing on previous music-piece information to write music information of the previous piece to a file and opening processing on next-piece file to form a next-piece file in the recording medium, wherein it is preferable to execute the closing processing on the next-piece file in a free time after occurrence of the change of music-piece.

Furthermore, it is preferable to execute the writing processing on the previous-piece music information in a free time after occurrence of the change of music-piece.

According to these, the file operation to change the music-piece is executed at a time zone other than the time of music-piece change in order to distribute the processing. Therefore, it is possible to shorten the time necessary for the processing that is to be performed when there is occurrence of music-piece change.

Moreover, in the case that the above-described closing processing on the previous-piece file is executed in a free time after occurrence of the change of music-piece, it is preferable to execute the closing processing on the previous-piece file in a free time after occurrence of the change of music-piece only when delay time, namely, from informing of a writing request till starting the processing for writing the music data stored in the storage device to the recording medium, becomes longer than a prescribed time.

Further, in the case that longer the above-described writing process on the previous-piece music information is executed in a free time after occurrence of the change of music-piece, it is preferable to execute writing process on the previous-piece music information in a free time only when delay time, namely, after occurrence of the change of music-piece of the change of music-piece from issuance of a writing request till starting processing for writing the music data stored in the storage device to the recording medium, becomes longer than a prescribed time.

According to this, it is possible to prevent unnecessary delay for producing the file by postponing the processing only when the delay time becomes more than a specific value, considering the delay time until starting writing of the music data stored in the storage device to the recording medium.

It is possible according to the present invention to improve the performance of the recording function without increasing the processing speed of the system controller and the access speed to the recording medium even if there is an increase in the input data amount for a specific time due to higher double-speed and high-quality.

The recording control method of the present invention is useful for digital audio players such as hard disc players and CD-R players, which record music data inputted successively from music playback equipments, etc. in a file form to a recording medium formatted by a file system. In addition, it is expected to improve the performance without increasing the cost for the products.

### BRIEF DESCRIPTION OF THE DRAWINGS

Other objects of the present invention will become clear from the following description of the preferred embodiments and the appended claims. Those skilled in the art will be reminded that there are many other advantages of the present invention which have been mentioned there by carrying out the present invention.

FIG. 1 is a block diagram to show the basic structure of a recording apparatus by which the present invention is carried out;

FIG. 2 is a flowchart for illustrating action of a control device during recording action of the recording apparatus according to a first embodiment of the present invention;

FIG. 3 is a flowchart for illustrating action of a system controller during recording action of the recording apparatus according to the first embodiment of the present invention;

FIG. 4 is a flowchart for illustrating file operation to change the music-piece performed by the system controller of the recording apparatus according to the first embodiment of the present invention;

FIG. 5 is a flowchart for illustrating action of a system controller during recording action of a recording apparatus according to a second embodiment of the present invention;

FIG. 6 is a flowchart for illustrating file operation to change the music-piece performed by the system controller of the recording apparatus according to the second embodiment of the present invention;

FIG. 7 is a block diagram to show the structure of a recording apparatus according to a third embodiment of the present invention;

FIG. 8 is a flowchart for illustrating action of a system controller during recording action of the recording apparatus according to the third embodiment of the present invention;

FIG. 9 is a flowchart for illustrating file operation to change the music-piece performed by the system controller of the recording apparatus according to the third embodiment of the present invention;

FIG. 10 is a flowchart for illustrating action of a system controller during recording action of a recording apparatus according to the related art; and

FIG. 11 is a flowchart for illustrating file operation to change the music-piece performed by the system controller of the recording apparatus according to the related art.

### DETAILED DESCRIPTION OF THE INVENTION

Preferred embodiments of the present invention will be described hereinafter by referring to the accompanying drawings.

### First Embodiment

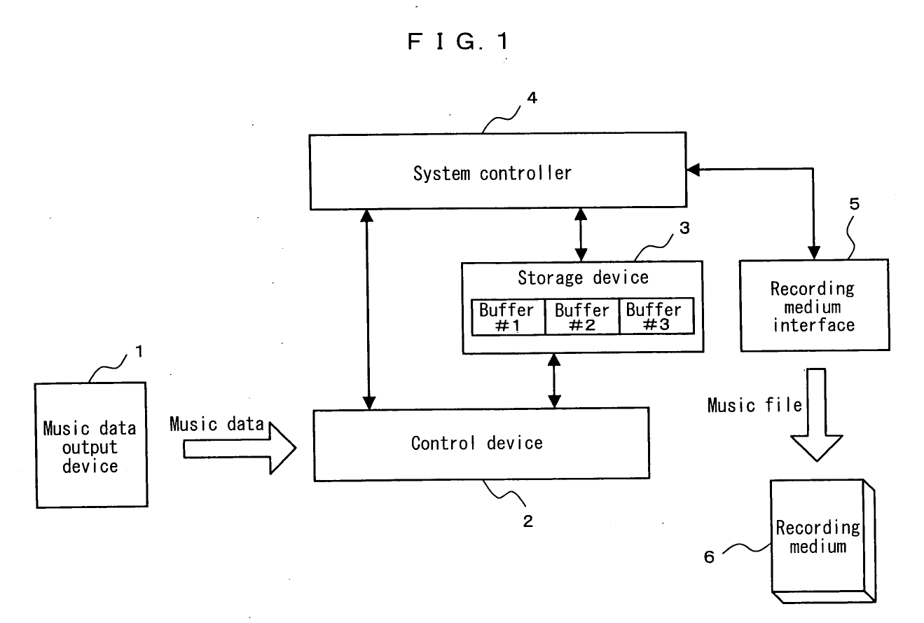

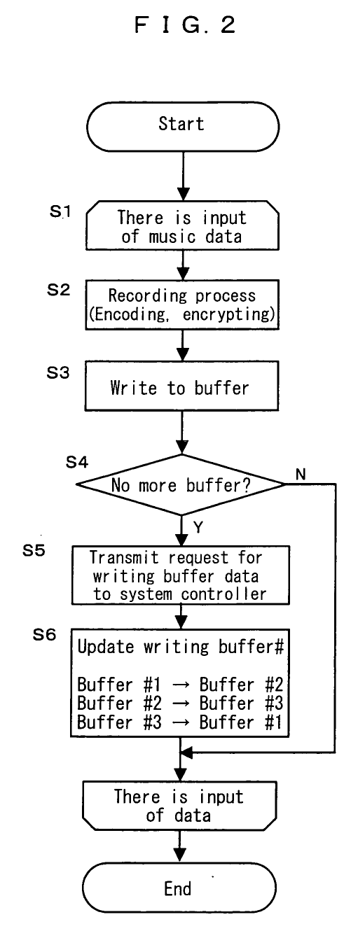

The structure of FIG. 1 used for describing the related art is basically applied to the structure of a recording apparatus according to a first embodiment of the present invention. However, functions of each structural element according to the embodiment are completely different from those of the conventional case. First, the processing procedures of a control device 2 at the time of recording action will be described by referring to FIG. 2.

When music data is inputted from a music data output device 1 in step S1, it proceeds to step S2 for starting recording. In step S2, recording processing (encoding and encrypting) is performed on the inputted data by every specific size, and the encrypted music data is stored in buffers of a storage device 3 in step S3. Then, it is monitored in step S4 to check whether or not there still remains the available capacity in the buffers. When it is judged that no capacity in the buffers remained (Yes in step S4), there is transmitted a request to write the music data of the buffer to a recording medium 6 to a system controller 4 in step S5. Then, in step S6, update (changeover) of writing buffer is carried out.

More specifically, when there is no available capacity in the first buffer #1, a writing request of the music data in the first buffer #1 is transmitted and, at the same time, data accumulation in second buffer #2 is started. Further, when there is no available capacity in the second buffer #2, a writing request of the music data in the second buffer #2 is transmitted and, at the same time, data accumulation in third buffer #3 is started. Furthermore, when there is no available capacity in third buffer #3, a writing request of the music data in the third buffer #3 is transmitted and, at the same time, data accumulation in the first buffer #1 is started again. The processing described above is repeatedly executed while the music data is being inputted.

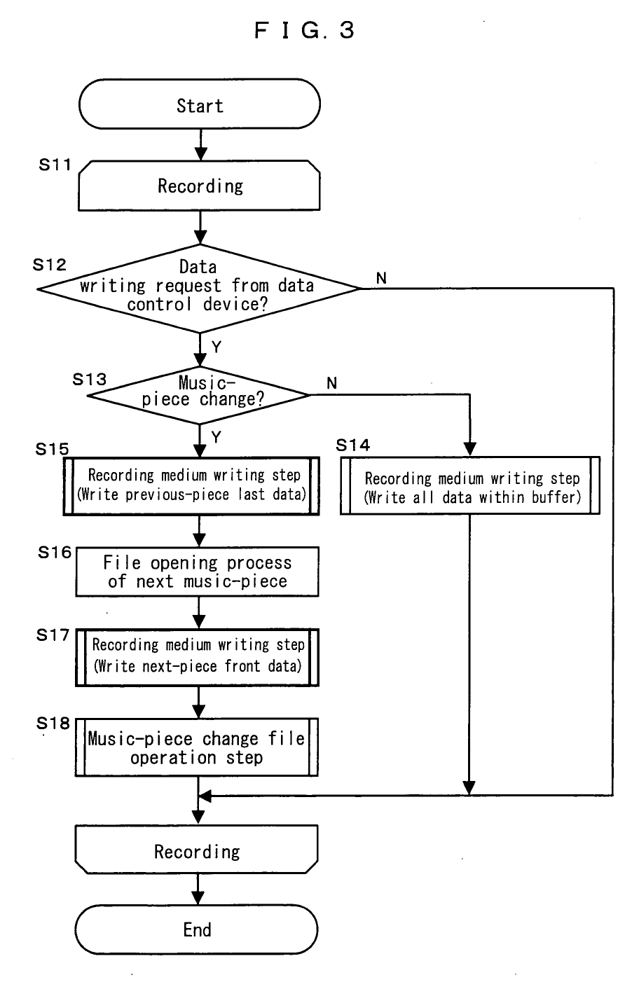

Next, processing procedures of the system controller (recorder) 4 at the time of recording action will be described by referring to a flowchart shown in FIG. 3. When recording is started, the system controller 4 enters into a recording loop in step S11, and comes in a state in step S12 for waiting a writing request from the control device 2. When a writing request is received from the control device 2 (Yes in step S12), it is judged in step S13 whether or not there is a change of music-piece.

When there is no change of music-piece (No in step S13), it proceeds to step S14 where all the music data in the designated buffer is written to the recording medium 6. When completed, it again comes in the state for waiting the writing request from the control device 2 (step S12).

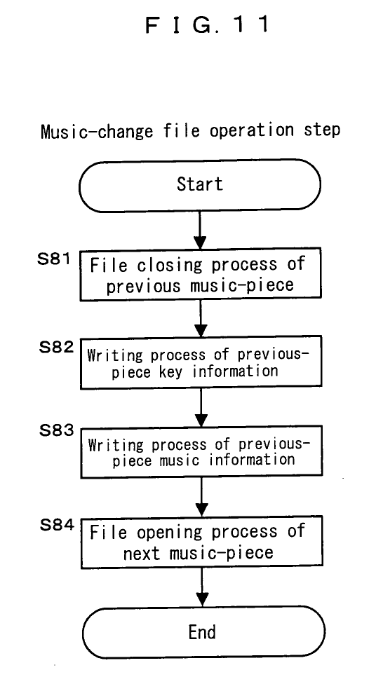

In the meantime, when there is a change of music-piece (YES in step S13), it means that the last data of the music data of the previous piece and the front data of the music data of the next piece are stored in the buffer. In that case, it proceeds to step S15 where the last data of the music data of the previous piece is written to :the recording medium 6. Then, in step S16, there is performed an opening process of the next music-piece file to produce a data file of the music data of the next piece. In the processing of the step S16, file processing is performed to store the music data of the next piece to the recording medium 6, which corresponds to step S84 of the related art shown in FIG. 11. In the embodiment, the processing of step S16 is executed prior to the processing of step 17 and thereafter. In step S17, the front data of the music data of the next piece is written to the recording medium 6. Thereby, reference to the buffer is completed. Then, it proceeds to the processing of file operation to change the music-piece in step S18.

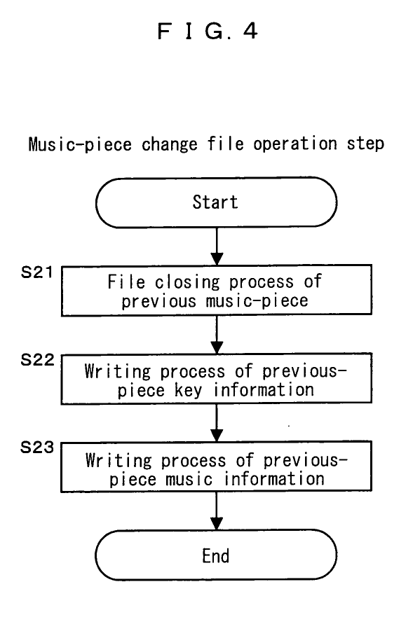

The file operation to change the music-piece in step S18 is performed as illustrated in FIG. 4. That is, closing process of the previous music-piece file is performed in step S21. In the closing processing of the previous music-piece file, processing for ending the storing processing of the music data is performed to the data file that stores the music data of the previous piece (referred to as previous music-piece data file hereinafter).

Then, in step S22, there is performed the writing process of key information for decrypting the encryption of the previous music-piece file to the recording medium. Subsequently, there is performed in step S23 the processing of generating the music information of the previous piece and writing it to the recording medium.

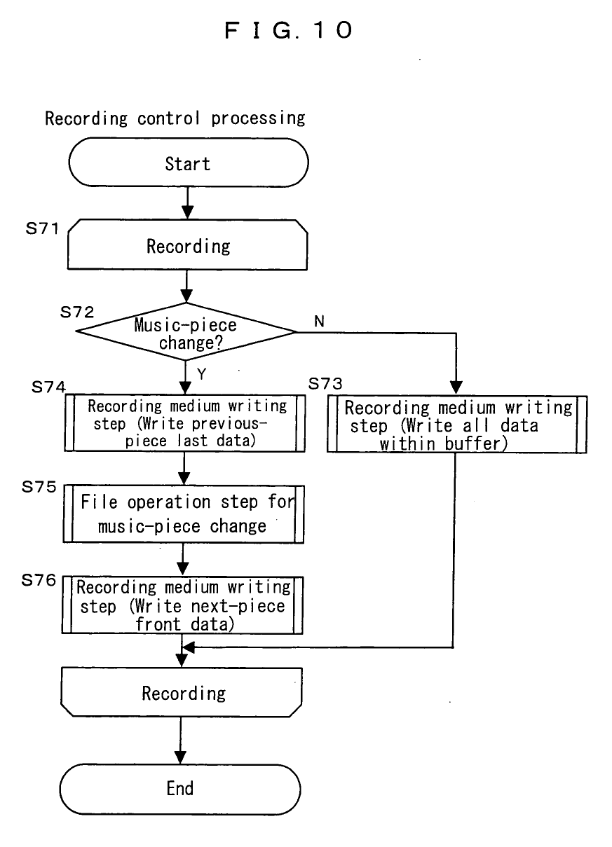

In the related art, as shown in FIG. 10, the file operation to change the music-piece (step S75) is performed between the writing process the last data of the music data of the previous piece to the recording medium 6 (step S74) and the writing process of the front data in the music data of the next piece to the recording medium 6 (step S76). In the meantime, in this embodiment, after the process writing the last data in the music data of the previous piece to the recording medium 6 (step S15), the process writing the front data of the music data in the next piece to the recording medium 6 (step S17) is performed prior to the file operation to change the music-piece (step S18). However, due to restriction of the file system, the music data cannot be written unless the file in the recording medium 6 to store the music data (music piece) is opened. Thus, the opening process of the next music-piece file is executed essentially prior to the processing (step S17) for writing the front data in the music data of the next piece to the recording medium 6.

As described, according to the recording control method according to the embodiment, it is possible to shorten the time to refers to the buffer during execution of the file operation to change the music-piece by the system controller 4, thereby allowing decrease in the possibility of missing the data in the recording apparatus caused by overwriting the buffer.

Hereby, it is possible to execute the recording action without increasing the processing speed of the system controller 4 and the access speed to the recording medium 6 corresponding to the increase in the input data amount for a specific time, for example, due to higher double-speed and high-quality.

### Second Embodiment

Like the first embodiment, the structure of FIG. 1 is applied to the structure of a recording apparatus according to a second embodiment of the present invention. The processing of the control device 2 is the same as that of the first embodiment shown in FIG. 2, so that the description thereof will be omitted.

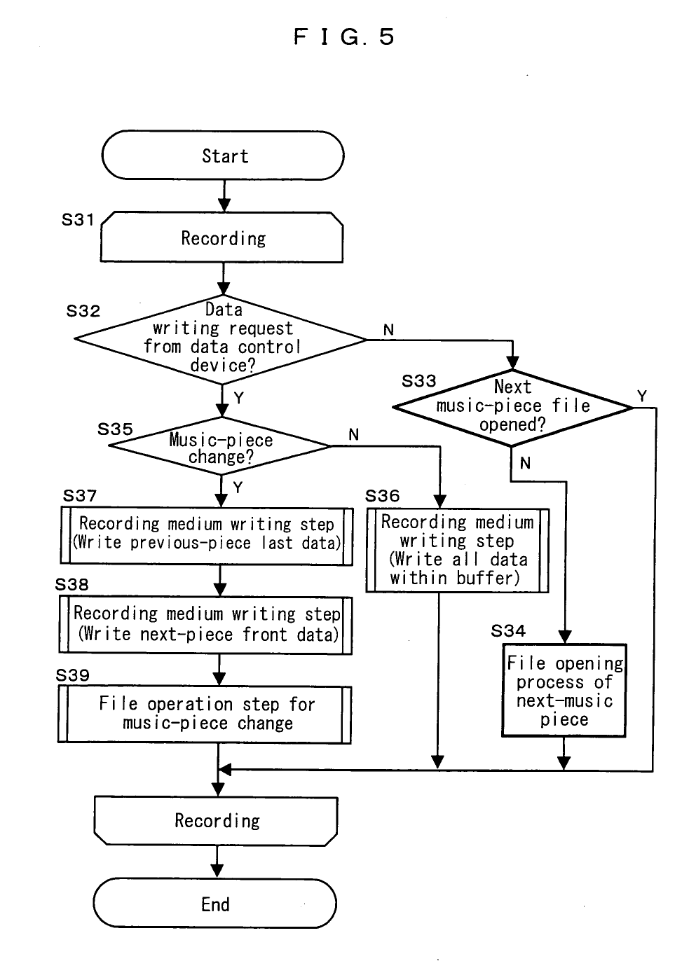

The processing procedures of the system controller (recorder) 4 according to this embodiment at the time of recording action will be described by referring to a flowchart shown in FIG. 5. When recording is started, the system controller 4 enters into a recording loop in step S31, and comes in a state in step S32 for waiting a writing request from the control device 2. When there is no writing request from the control device 2 (No in step S32), it proceeds to step S33 where it is judged in the recording medium 6 whether or not the file for recording the music data of the next piece is opened. If not opened, it proceeds to step S34 where the opening process for the next music-piece file is performed to the recording medium 6 for generating the data file of the next piece. That is, the opening processing of the next music-piece file is performed to the recording medium 6 during a free time before occurrence of the change of music-piece. The processing in step S34 corresponds to step S16 of the first embodiment, and this process is performed in a free time before the occurrence of music-piece change. When the opening process of the next music-piece file is completed, it again comes in a state for waiting the writing request from the control device 2 (step S32).

In the meantime, when there is a writing request from the control device 2 (Yes in step S32), it proceeds to step S35 to judge whether or not there is occurrence of music-piece change. When there is no change of music-piece (No in step S35), it proceeds to step S36 where all the music data in the designated buffer is written to the recording medium 6. After completion, it again comes in state for waiting the writing request from the control device 2 (step S32).

In the meantime, when there is a change of music-piece (Yes in step S35), it means that the last data in the music data of the previous piece and the front data in the music data of the next piece are stored within the buffer. In this case, it proceeds to step S37 where the last data in the music data of the previous piece is written to the recording medium 6. The opening processing of the next music-piece file has been completed by this time(step S34). Then, in step S38, the front data in the music data of the next piece is written to the recording medium 6. Thereby, reference to the buffer is completed. Then, it proceeds to the processing of file operation to change the music-piece in step S39.

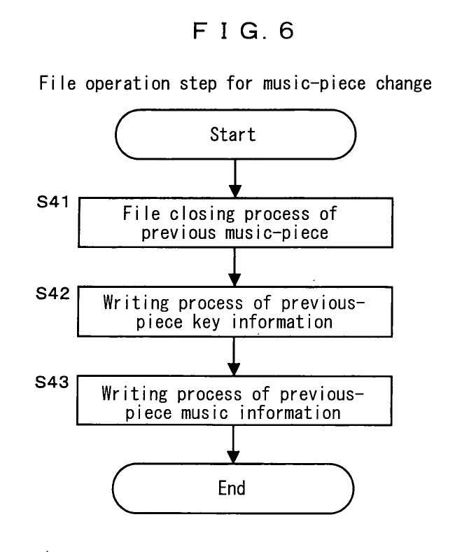

The file operation to change the music-piece of step S39 is performed as illustrated in FIG. 6. That is, closing process of the previous music-piece file is performed to the recording medium 6 to finish formation of the previous music-piece data file in step S41. Then, in step S42, key information for decrypting the encryption of the music data of the previous piece is written to the recording medium 6 (writing process of the previous-piece key information). Subsequently, there is performed in step S43 the process of preparing the music information of the previous piece and writing it to the recording medium 6. These steps are the same as those of the first embodiment shown in FIG. 4.

In the embodiment as described above, the opening process of the next music-piece file, which is conventionally executed when there is occurrence of music-piece change, is performed within the time for waiting the writing request but not at the time of music-piece change, i.e. within a free time before the occurrence of music-piece change. Hereby, processing time by the system controller 4 at the time of music-piece change is shortened, thereby shortening the delay time from issuance of the writing request by the control device 2 till the system controller 4 writes to the recording medium 6.

Hereby, it is possible to decrease probability of processing omission of the system controller, which is caused by an increase in the input data amount for a specific time due to higher double-speed and high-quality, for example.

In the embodiment, it is illustrated to execute the opening process of the next music-piece file (step S34) related to the file operation to change the music-piece during the time other then the time of music-piece change. However, it may be structured to execute writing process of the previous-piece key information (step S42) related to the file operation to change the music-piece during the time other then the time of music-piece change. It is also possible in this case to achieve the similar effect in shortening the processing time of the file operation to change the music-piece.

### Third Embodiment

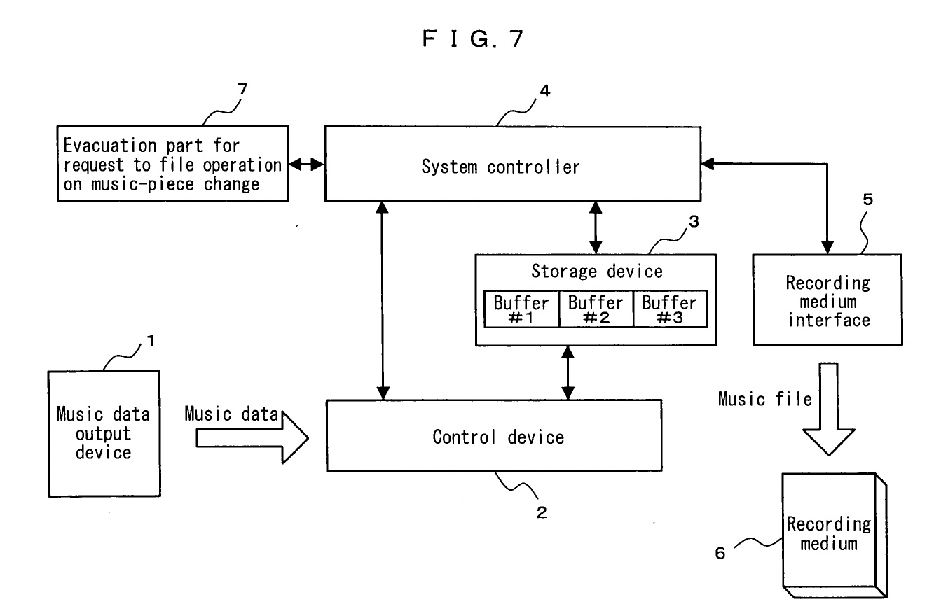

FIG. 7 is a block diagram to show the structure of a recording apparatus according to a third embodiment of the present invention. In FIG. 7, reference numeral 7 is an evacuation part to request for a file operation to change the music-piece. The safety part for operation request 7 performs evacuating (cueing) process to request of the file operation to change the music-piece request, if delay time for writing the music data to the recording medium 6 is more than a specific time when there is a writing request from the control device 2 to the system controller 4. The closing process of the data file in the recording medium 6 where the previous music data is stored is not carried out at this time point and postponed.

In the recording apparatus of the embodiment, as the processing of the control device 2 is the same as that of the first embodiment shown in FIG. 2, the description thereof will be omitted.

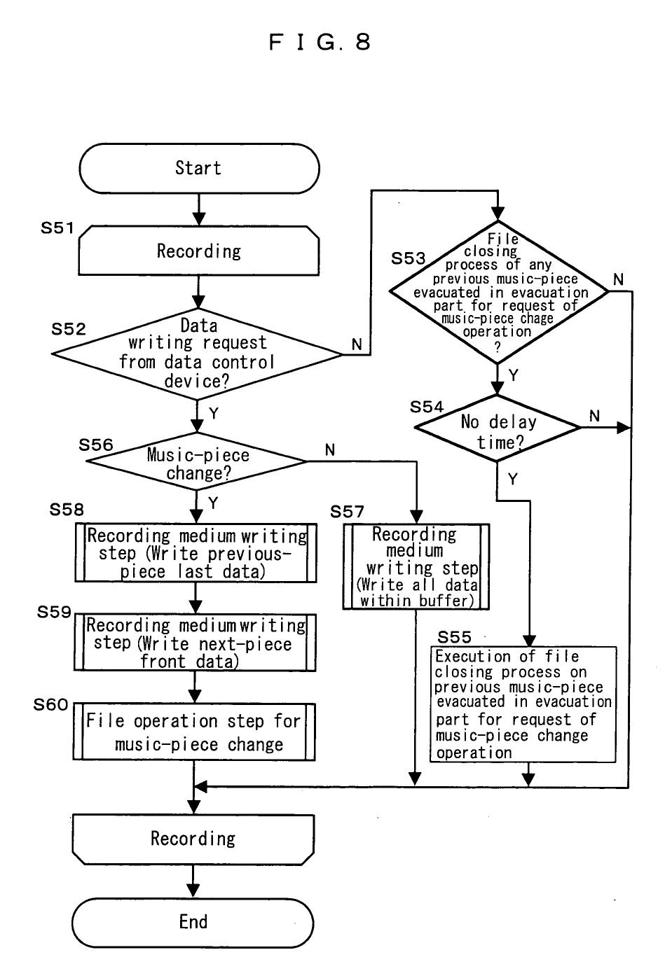

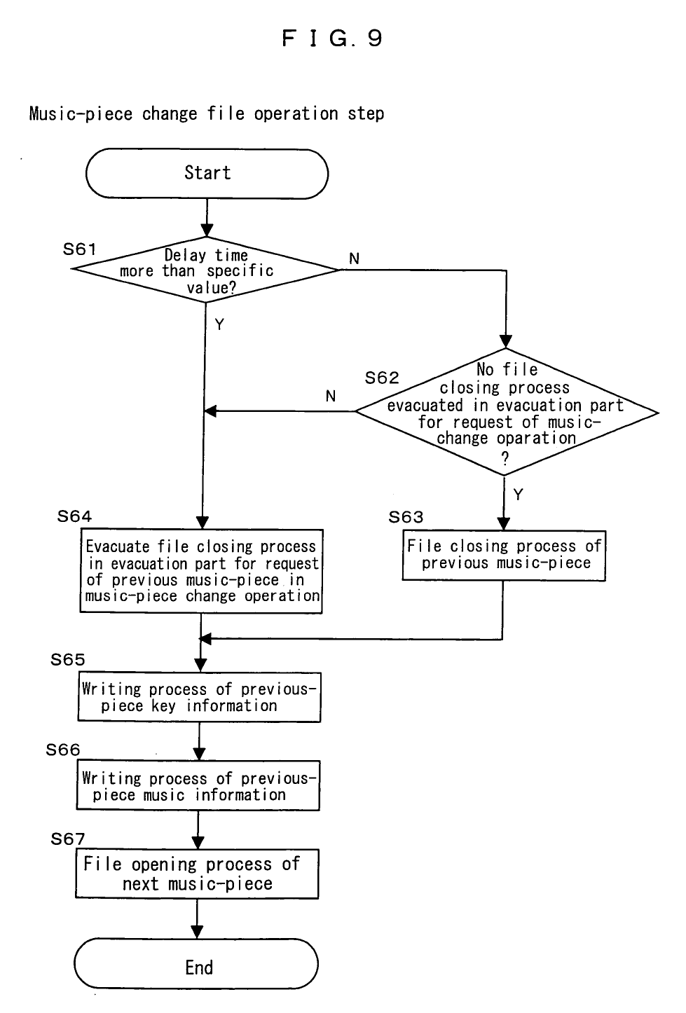

The processing procedures of the system controller (recorder) 4 according to this embodiment at the time of recording action will be described by referring to a flowchart shown in FIG. 8. When recording is started, the system controller 4 enters into a recording loop in step S51, and comes in a state in step S52 for waiting a writing request from the control device 2. When there is no writing request from the control device 2 (No in step S52), it proceeds to step S53 where it is judged whether or not there is the closing process (process for closing the data file to which the music data of the previous piece is stored) for the file that is already evacuated (cued) in the file operation to change the music-piece request evacuation part 7 (the cueing is performed in step S64 of FIG. 9). If there exists the closing process for the previous music-piece file that is already evacuated (Yes in step S53), it proceeds to step S54 for referring to the delay time from issuance of the writing request by the control device 2 till the system controller 4 write the music data to the recording medium 6. If there is no delay time (Yes in step S54), it proceeds to step S55 where there is performed the closing process for the previous music-piece file that is evacuated in the evacuation part 7 to request for the file operation to change the music-piece request. When the closing process of the previous music-piece file is completed, it again comes in a state for waiting the writing request from the control device 2 (step S52).

When there is a writing request from the control device 2 (Yes in step S52), it proceeds to step S56 to judge whether or not there is a change of music-piece. When there is no change of music-piece (No in step S56), it proceeds to step S57 where all the music data in the designated buffer is written to the recording medium 6. After completion, it again comes in state for waiting the writing request from the control device 2 (step S52).

In the meantime, when there is a change of music-piece (Yes in step S56), it means that the last data in the music data of the previous piece and the front data in the music data of the next piece are stored within the buffer. In this case, it proceeds to step S58 where the last data in the music data of the previous piece is written to the recording medium 6. Then, in step S59, the front data in the music data of the next piece is written to the recording medium 6. Thereby, reference to the buffer is completed. Then, it proceeds to the process of file operation to change the music-piece in step S60.

The file operation to change the music-piece of step S60 is performed as illustrated in FIG. 9. That is, in step S61, there is referred to the delay time which is from issuance of the writing request by the control device 2 till the system controller 4 writes the music data to the recording medium 6. If the delay time is longer than a specific time that is set in advance (Yes in step S61), the closing process for the previous music-piece file is not performed at this point. It proceeds to step S64 where the closing process for the previous music-piece file is evacuated in the evacuation part 7 for request to the file operation to change the music-piece. In the meantime, if there is no delay time or the delay time is less than the specific time (No in step S61), it proceeds to step S62 where it is judged whether or not there is the closing process for the previous music-piece file that has already been evacuated in the file operation to change the music-piece request saving part 7. When judged that there exists the closing processing for the previous music-piece file that has already been evacuated (No in step S62), it proceeds to step S64. In the meantime, when judged that there is no closing processing for the previous music-piece file evacuated in the evacuation part 7 for request to the file operation to change the music-piece (Yes in step S62), it proceeds to step S63. At this point, the closing process for the previous music-piece file is performed. That is, if there is enough time, the closing process for the previous music-piece file is performed immediately.

Then, in step S65, there is performed the writing process to write the previous-piece key information to the recording medium 6, which is the key information to decrypt the encryption of the previous music-piece file. Subsequently, there is performed in step S66 the process writing the music information of the previous piece to the recording medium 6. Then, in step S67, the opening process of the next music-piece file is performed.

In the embodiment as described above, the closing process of the previous music-piece file, which is conventionally executed when there is occurrence of music-piece change, is performed within the time for waiting the writing request after occurrence of the music-piece change. Hereby, processing time by the system controller 4 at the time of music-piece change is shortened, thereby shortening the delay time from issuance of the writing request by the control device 2 till the system controller 4 performs writing to the recording medium 6.

Therefore, it becomes possible to decrease probability of processing omission of the system controller, which is caused by an increase in the input data amount within a specific time, for example, due to higher double-speed and high-quality.

Furthermore, it is possible to prevent unnecessary delay for forming the file by monitoring the delay time from issuance of the writing request by the control device 2 till performing writing to the recording medium 6 in order to delay the process only when the delay time becomes more than a specific value.

In the embodiment, the process for closing the music data file of the previous piece in the file operation to change the music-piece (FIG. 9) is performed after occurrence of music-piece change. However, the effect of shortening the processing time of the file operation to change the music-piece can be achieved similarly by performing the writing process of the music information of the previous piece of step S66 during the time other than the time of music-piece change.

The present invention has been described in detail by referring to the most preferred embodiments. However, it is possible that the combinations and arrangements of the components in the preferred embodiments are changed without departing from the sprit and the scope of the appended claims in the invention.

What is claimed is:

1. A recording control method, wherein a music data, which contains one or a plurality of music pieces and is inputted successively, is stored to a storage device, and the music data stored in the storage device is recorded with a file form by each piece to a recording medium formatted in a file system, the method comprises the steps of:
When a change of music-piece has occurred in the music data stored in the storage device, the stored music data of previous piece is written to the recording medium until last data thereof; and
After the last data has been written to the recording medium, a front data of the music data of next piece stored in the storage device is written to the recording medium; and
After the front data is written to the recording medium,: file operation to change the music-piece is executed.

2. The recording control method according to claim 1, wherein the file operation to change the music-piece includes:
Process to end writing process of the music data of the previous piece to the recording medium;
Process to write a key information of previous-piece, namely, writing process for writing key information of the previous piece to an authentication area of the recording medium;
Process to write an information on the previous-piece music, that is, process to write a music information of the previous piece to a data file of the recording medium containing the music data of the previous piece; and
Opening process of the next-piece file for executing file process to the recording medium that is necessary to write the music data of the next piece,
Wherein opening process of the next-piece file is executed between writing process of the last data to the recording medium and writing process of the front data to the recording medium.

3. The recording control method according to claim 1, wherein the file operation to change the music-piece includes:
Closing process of the previous-piece file for ending writing process of the music data of the previous piece to the recording medium;
Writing process of previous-piece key information for writing key information of the previous piece to an authentication area of the recording medium;
Writing process of the previous-piece music information for writing music information of the previous piece to a data file of the recording medium containing the music data of the previous piece; and
Opening process of next-piece file for executing file process to the recording medium that is necessary to write the music data of the next piece to the recording medium, wherein
The opening process of next-piece file is executed in a free time before occurrence of the change of music-piece.

4. The recording control method according to claim 3, wherein, further, the writing process of the previous-piece key information is executed in a free time before occurrence of the change of music-piece.

5. The recording control method according to claim 1, wherein the file operation to change the music-piece includes:
Closing process of the previous-piece file for ending writing process of the music data of the previous piece to the recording medium;
Writing process of previous-piece key information for writing key information of the previous piece to an authentication area of the recording medium;
Writing process of the previous-piece music information for writing music information of the previous piece to a data file of the recording medium containing the music data of the previous piece; and
Opening process of next-piece file for executing file process to the recording medium that is necessary to write the music data of the next piece to the recording medium,
wherein
The closing process of the next-piece file is executed in a free time after occurrence of the change of music-piece.

6. The recording control method according to claim 5, wherein, the writing process of the previous-piece music information is executed in a free time after occurrence of the change of music-piece.

7. The recording control method according to claim 5, wherein, the closing process of the previous-piece file is executed in a free time after occurrence of the change of music-piece only when delay time, which is from issuance of a request to write the music data stored in the storage device to the recording medium till starting process for writing the music data stored in the storage device to the recording medium, becomes a prescribed time or longer.

8. The recording control method according to claim 6, wherein, the writing process of the previous-piece music information is executed in a free time after occurrence of the change of music-piece only when delay time, which is from issuance of a request to write the music data stored in the storage device to the recording medium till starting process for writing the music data stored in the storage device to the recording medium, becomes a prescribed time or longer.

9. A recording apparatus comprising:
A storage device for storing music data containing one or a plurality of pieces of music being inputted successively;
A recorder for recording the music data stored in the storage device with a file form by each piece to a recording medium formatted by a file system; and
A control device for controlling the storage device and the recorder, wherein
When a change of music-piece occurs in the music data stored in the storage device, the control device gives an instruction to the storage device and the recorder to execute file operation to change the music-piece after writing last data of previous piece and front data of next piece, which are stored in the storage device, to the recording medium in order from the last data to the front dada.

10. The recording apparatus according to claim 9, wherein; when the process to write the music data of the previous piece to the recording medium in the file operation to change the music piece is finished, process is carried out to write music information of the previous piece to a data file of the recording medium containing the music data of the previous piece after writing key information of the previous piece in an authentication area of the recording medium, and further the control device gives an instruction to the storage device and the recorder to make the recording medium perform file process that is necessary for writing the music data of the next piece on the recording medium between writing of the last data to the recording medium and writing of the front data to the recording medium.

11. The recording apparatus according to claim 9, wherein; when the process to write the music data of the previous piece to the recording medium in the file operation to change the music piece is finished, process is carried out to write music information of the previous piece to a data file of the recording medium containing the music data of the previous piece after writing key information of the previous piece in an authentication area of the recording medium, and further the control device gives an instruction to the storage device and the recorder to make the recording medium perform file process that is necessary for writing the music data of the next piece in a free time before occurrence of the change of music-piece.

12. The recording apparatus according to claim 11,
wherein the control device gives an instruction to the storage device and the recorder to write the previous-piece key information into the authentication area of the recording medium in a free time before occurrence of the change of music-piece.

13. The recording apparatus according to claim 9, wherein; when the process to write the music data of the previous piece to the recording medium in the file operation to change the music piece is finished, process is carried out to write music information of the previous piece to a data file of the recording medium containing the music data of the previous piece after writing key information of the previous piece in an authentication area of the recording medium, and further the control device gives an instruction to the storage device and the recorder to make the recording medium perform file process that is necessary for writing the music data of the next piece in a free time after occurrence of the change of music-piece.

14. The recording control apparatus according to claim 13, wherein the control device gives an instruction to the storage device and the recorder to execute writing process on the music information of the previous-piece in a free time after occurrence of the change of music-piece.

15. The recording apparatus according to claim 13, wherein the control device gives an instruction to the storage device and the recorder to execute process for ending writing of the music data of the previous piece in a free time after occurrence of the change of music-piece only when delay time, which is from issuance of a request to write the music data stored in the storage device to the recording medium and till starting process for writing the music data stored in the storage device to the recording medium, becomes a prescribed time or longer.

16. The recording apparatus according to claim 14, wherein the control device gives an instruction to the storage device and the recorder to execute process for writing the music information of the previous-piece in a free time after occurrence of the change of music-piece only when delay time, which is from issuance of a request to write the music data stored in the storage device to the recording medium and till starting process for writing the music data stored in the storage device to the recording medium, becomes a prescribed time or longer.
